(19) United States
(12) Patent Application Publication
(10) Pub. No.: US 2009/0128815 A1
(43) Pub. Date: May 21, 2009

(54) REMOTE CONTROL POINTING TECHNOLOGY WITH ROLL DETECTION

(75) Inventors: Maurice Herman Johan Draaijer, Eindhoven (NL); Egbert Wouter Joghum Robers, Delft (NL); Galileo June Destura, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/282,667

(22) PCT Filed: Mar. 2, 2007
(86) PCT No.: PCT/IB07/50682

§ 371 Date: Sep. 12, 2008

(30) Foreign Application Priority Data
Mar. 15, 2006 (EP) 06111210.8

(51) Int. Cl. G01J 4/00; G01B 11/26

(52) U.S. Cl. 356/364; 356/139.04

(57) ABSTRACT

A roll detection system is disclosed for detecting a roll angle of a light emitting apparatus around a longitudinal axis thereof. The light emitting apparatus preferably is a pointing device (2). The system furthermore comprises a light detecting arrangement (4) for detecting light emitted by the pointing device (2) and means for determining where the pointing device is pointed. The pointing device (2) comprises at least a first (X1) and a second light source (Y1). The first (X1) and second light source (Y1) emit light with a different polarization orientation. The light detecting arrangement (4) is equipped with a polarization filter (3). The orientation of the polarization of the light emitted by the first (X1) and second light source (Y1) differs by an angle unequal to 90°. With the system the roll angle of the pointing device (2) can be determined for a large angle range.

### BACKGROUND OF THE INVENTION

1. Technical Field

The present invention generally relates to remote control pointing technology with roll detection and more particularly to a roll detection system for determining a roll angle of a light emitting apparatus around a longitudinal axis thereof.

The present invention also relates to a light emitting apparatus and light detecting arrangements for use in such a system.

2. Description of Related Art

For easy interaction between a user and interactive content point-and-click operations, typically using a computer mouse, are very common and accepted. Usually, these operations are performed close to the screen and require a flat surface or a device, which is either hard to use or very expensive.

On the other hand, for lean-back and relax applications, e.g. watching video and listening to music, the remote control (RC) is commonly used. It can also be observed that the number of RC buttons is growing rapidly due to the growing complexity of the applications it controls. This has led to discontent and confusion on the part of the users on which buttons to press for a specific application.

The current problem is being compounded by the convergence of the traditional lean-back applications with the PC applications with the internet being the backend supporting infrastructure. A dilemma arises with the convergence as both the lean back and PC world have different interaction means.

In order to deal with this problem remote control pointing technology has been developed. Using a remote control hand held device comprising a number of Infra Red (IR) light emitting diodes (LEDs) and a light detector near a screen it is possible to determine where a user is pointing the device in relation to the screen. This enables users to make point-and-click operations or make gestures that can be recognized in the vicinity of the screen.

It is often unavoidable, that there is a slight rotation around the longitudinal axis (roll axis) of the pointing device when it is moved. It is not desirable that this roll of the pointing device affects the determination of the position where the pointing device is pointed to. Thereto, it is needed to quantify the roll error and compensate for this error. Alternatively, the roll action may be used as an extra degree of freedom in control, in addition to movement.

A system in which the roll of a pointing device may be determined is disclosed in the patent application US 2004/0222969. The pointing device is a light emitting apparatus comprising two polarized light sources, the first one with a polarization angle of −45°, the second one with a polarization angle of 45°. The light detecting device is equipped with a vertical polarization filter. This allows the detection of the roll angle for an angle range of 90°.

It is an object of the invention to provide a system in which the roll angle of a light emitting apparatus can be detected for a larger angle range.

### SUMMARY OF THE INVENTION

These and other objects of the invention are achieved by a roll detection system according to independent claim 1, a light emitting apparatus according to independent claim 16 and light detecting arrangements according to claims 17 and 18. Favorable embodiments are defined by the dependent claims 2-15.

According to an aspect of the invention there is provided a roll detection system comprising a light emitting apparatus, a light detecting arrangement and means for determining a roll angle of the light emitting apparatus around a longitudinal axis thereof. The light emitting apparatus preferably is a pointing device which can be pointed by a user in relation to a screen. The light emitting apparatus comprises at least a first light source being adapted for mainly or exclusively emitting light with a certain polarization orientation and a second light source being adapted for mainly or exclusively emitting light with a certain polarization orientation different from the polarization orientation of the light emitted by the first light source. The light detecting arrangement comprises a detector being adapted for mainly or exclusively detecting light with a certain polarization orientation. The orientation of the polarization of the light emitted by the first and second light source differs by an angle unequal to 90°.

The invention is based on the recognition that, by using two light sources having an orientation of the polarization light sources which differs by an angle (substantially) different from 90°, the roll can be detected for a larger angle range than according to the prior art. This is particularly advantageous in systems that use “rolling” movements as an additional way for generating commands. The intensity of the detected light with a certain polarization orientation from the first and the second light source varies as a function of the roll angle. By measuring the light intensity received from both the first and the second light source the roll angle of the light emitting apparatus can be determined. Preferably, the division of the light intensity of the first and second light source is used for determining the roll angle. In this way the system does not rely on signal strength itself, but on the division of two signal strengths making it less sensitive for environmental (background) light conditions.

According to an embodiment the orientation of the polarization of the light emitted by the first and second light source differs between 10° and 70°. This enables roll angle detection with a good accuracy over a relatively large range.

According to a further embodiment the different polarization of the first and second light sources is obtained by equipping them with polarization filters with a different orientation. The use of polarization filters is a very efficient and cheap way for generating polarized light.

Advantageously, the light detecting arrangement comprises a polarization filter for mainly or exclusively detecting the light with a certain polarization orientation. The use of a polarization filter is a very efficient and cheap way for detecting polarized light.

Preferably, the first and second light sources are equipped with substantially less than 100% efficient light blocking polarization filters. In this way, it is avoided that the detected intensity of a light source becomes zero or close to zero at a certain roll angle, which is the case if 100% efficient filters are used. If the detected intensity of a light source becomes zero or close to zero, it is not possible to determine the pointing direction of the light emitting apparatus.

In an alternative embodiment the polarization filters are switched on and off. In this way, the roll angle and pointing direction of the light emitting apparatus can be detected with only one detector. The switching can be done in two ways: in the pointing device or in the light detecting arrangement at the receiver side. The roll can be detected while polarization filter(s) is (are) enabled, and the pointing direction can be detected when the filters are off.

Alternatively or additionally, the light detecting arrangement comprises a further detector for equally detecting light with any polarization orientation. Also in this way, it is avoided that the detected light intensity of a light source becomes zero or close to zero at a certain roll angle. Reliable determination of the pointing direction of the light emitting apparatus is possible in all these embodiments.

Preferably, the light emitting apparatus further comprises a third and a fourth light source. The first and the third light source are placed along a first axis. They are adapted for emitting light with the same polarization orientation. The first and the third light source have a mutually different radiation pattern. The second and the fourth light source are placed along a second axis perpendicular to the first axis. They are adapted for emitting light with the same polarization orientation. The second and the fourth light source have a mutually different radiation pattern. In case a light emitting apparatus with this structure is used, its roll angle can be calculated by using the sum of the intensities of the first and the third light source and the sum of the intensities of the second and the fourth light source, respectively. The difference in the detected light intensity of the first and third light source determines the position where the user is pointing in a first direction. The difference in the detected light intensity of the second and fourth light source determines the position where the user is pointing in a second direction. In this way, the movement in a first direction, a second direction and the roll angle can be obtained in an effective way.

According to an alternative embodiment the light emitting apparatus comprises a third light source adapted for emitting un-polarized light. This third light source may be used as a reference. In this way, the roll can be detected for an angle range of 180°.

According to a further alternative embodiment the light emitting apparatus comprises a third light source adapted for emitting polarized light with a different polarization orientation than the first and the second light source. By adding a third polarized light source an increased accuracy of the angle measurements is achieved.

According to a further preferred embodiment the light emitting apparatus comprises a detector for detecting the orientation of the light emitting apparatus with respect to the earth. As a general rule this orientation approximately corresponds to the roll angle of the light emitting apparatus. The light emitting apparatus is equipped for adapting the light emitted by at least one of the light sources as a function of the detected orientation. The orientation detector is for example a gravitation detector or an earth magnetic field detector, such as a Hall sensor. According to this embodiment at the receiving side roll detection for an angle range of 360° is in principle possible.

According to a first possibility the light emitting apparatus is adapted for switching the at least one light source on in case that the detected orientation of the light emitting apparatus lies in a first range and for switching the at least one light source off in case that the detected orientation of the light emitting apparatus lies in a second range.

Alternatively, the at least one of the light sources of the light emitting apparatus is adapted for mainly or exclusively emitting light with a certain polarization orientation in case that the detected orientation of the light emitting apparatus lies in a first range and for emitting un-polarized light in case that the detected orientation of the light emitting apparatus lies in a second range.

The first range preferably runs from 0° to 180° (the “upright” position) and the second range runs from 180° to 360° (the “turn round” position). So, the light emitted by the light emitting apparatus in case of an orientation between 0° and 180° is different from the light emitted in case of an orientation between 180° and 360°. Since the orientation with respect to the earth generally corresponds to the roll angle, the receiving end is provided with information if the roll angle lies between 0° and 180° or between 180° and 360°. Within these ranges the roll angle is more precisely determined by using the intensity of the detected light with a certain polarization orientation from the light sources.

According to a further alternative possibility the light emitting apparatus is adapted for transmitting information about the detected orientation by modulating the light emitted by the at least one of the light sources. This information may be used at the receiving end for determining the roll angle in addition to the intensity of the detected light with a certain polarization orientation coming from the light sources.

According to a further aspect of the invention a light emitting apparatus and light detecting arrangements are provided for use in a roll detection system

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawing, in conjunction with the accompanying specification, in which:

FIG. 1 shows a pointing device.

FIG. 2 shows the pointing device with its shielding means.

FIG. 3 shows a top view of the pointing device pointed to a light detector.

FIG. 4 shows a top view of the pointing device when pointed away from the light detector.

FIG. 5 shows a front view of the polarized light sources of the pointing device

FIG. 6 shows a block diagram of the light detector and the signal processing means at the receiving end.

FIG. 7 shows a block diagram of the light detector and the signal processing means at the receiving end according to an alternative example.

FIG. 8 shows the light strengths as a function of the roll angle of the pointing device with the structure according to FIG. 5 for a first polarization orientation difference.

FIG. 9 shows the division of the light strengths as a function of the roll angle of the pointing device for the first polarization orientation difference.

FIG. 10 shows the light strengths as a function of the roll angle of the pointing device with the structure according to FIG. 5 for a second polarization orientation difference.

FIG. 11 shows the division of the light strengths as a function of the roll angle of the pointing device for the second polarization orientation difference.

FIG. 12 shows a front view of polarized light sources according to an alternative example.

FIG. 13 shows the light strength as a function of the roll angle of the pointing device with the structure according to FIG. 12.

FIG. 14 shows the light strength as a function of the roll angle of a pointing device comprising a gravitation or earth magnetic field detector according to a first alternative.

FIG. 15 shows the light strength as a function of the roll angle of a pointing device comprising a gravitation or earth magnetic field detector according to a second alternative.

Throughout the figures like reference numerals refer to like elements.

### DETAILED DESCRIPTION OF THE PRESENT INVENTION

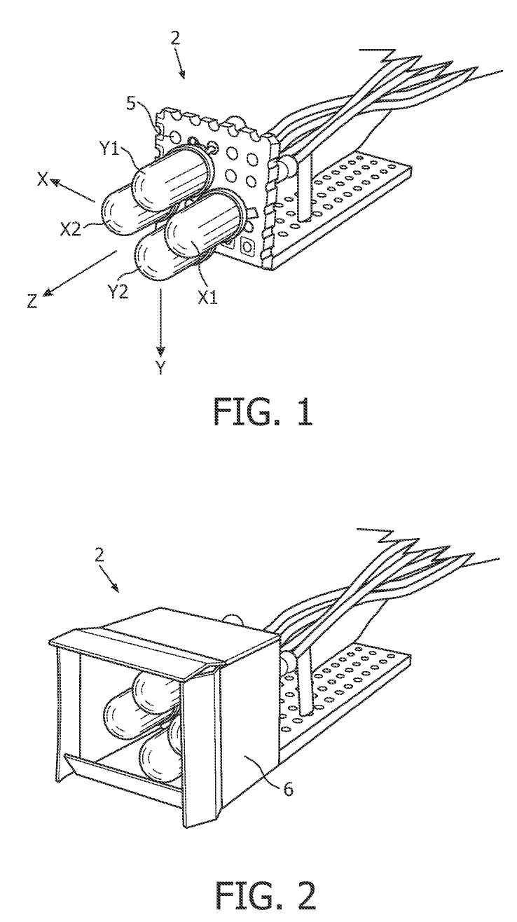

In this detailed description the light emitting apparatus of which the roll angle is to be determined is a pointing device which can be pointed by a user in relation to a screen. However, the invention can also be applied to light emitting apparatuses other than pointing devices. FIG. 1 shows a pointing device 2. It has four symmetrically arranged light sources, for example LEDs which are placed on a substrate 5. Two of the LEDs X1,X2 are placed symmetrically along a first, horizontal axis X. The other two LEDs Y1,Y2 are placed symmetrically along a second, vertical axis Y. The LEDs all point substantially in the same direction, along a third, longitudinal axis Z, which is perpendicular to the first and the second axis.

The four light sources transmit coded signals. This can be done by using frequency multiplexing (different flashing frequencies) code multiplexing (different orthogonal codes), wavelength multiplexing (different wavelengths) or a time division multiplexing technique (different flashing times).

The light sources are all adapted for emitting polarized light. Preferably, the light sources are LEDs emitting un-polarized light equipped with a polarization filter (not shown in FIG. 1). However, also light sources of the type that emit polarized light such as lasers may in principle be used.

As shown in FIG. 2, according to a first example the pointing device comprises shielding means 6 having the shape of a squared cavity which is placed symmetrically around the four LEDs. The walls of the squared cavity slightly surpass the LEDs in the direction of the Z-axis. This is necessary for shielding a part of the light emitted, if the pointing device is pointed away from a light detector. Due to the shielding the light sources have mutually different radiation patterns. In this way, the receiving side is enabled to determine the pointing position of the pointing device. In addition to the use of light shielding means as explained with reference to FIG. 2, mutually different radiation patterns of the light sources may be generated in various alternative ways. The light sources may be pointed a little bit outwards as described in U.S. Pat. No. 4,565,999 or a lens may be placed in front of the light sources, as described in U.S. Pat. No. 5,949,402. The teaching of U.S. Pat. No. 4,565,999 and U.S. Pat. No. 5,949,402 is incorporated into this description by reference.

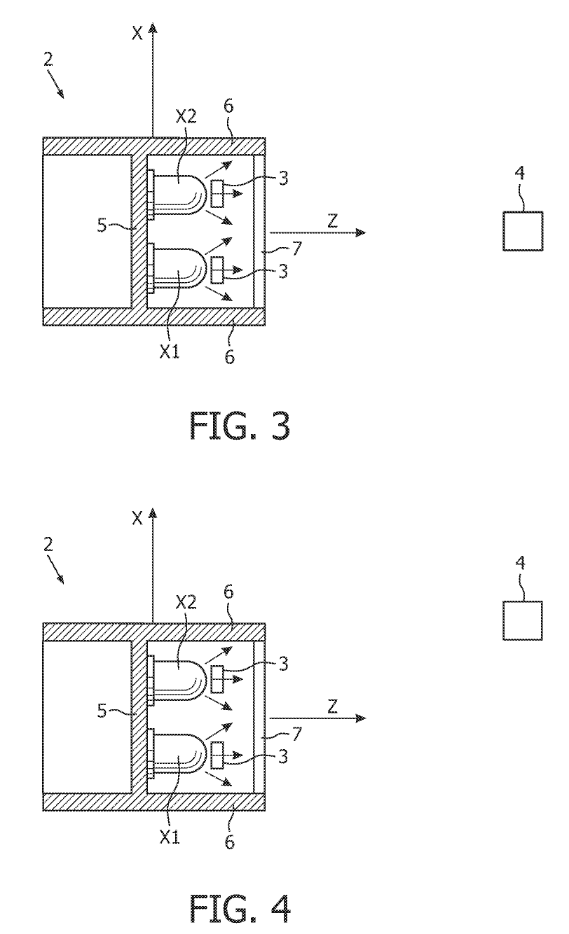

FIG. 3 shows a top view of the pointing device depicted in FIG. 1 when it is directed to a standard single light detector 3 for example a photo diode like to the ones used for (TV) infrared remote control. In this figure the polarization filters 3 of the light sources are shown. The pointing device 2 optionally comprises a common optical diffuse 7, resulting in relatively flat intensity patterns of the light sources. When the light sources in the cavity are pointed towards a light detector, the light signals of all four sources are received by the light detector. As shown in FIG. 4, when the light sources in a cavity are pointed slightly away from the detector one or two light sources are shielded more by the cavity edges as compared to the other light sources. Then the signal intensity of these light sources that are shielded more, received by the detector is reduced. In the configuration according to FIG. 4 the signal intensity of the light source X2 as received by the detector 4 is reduced.

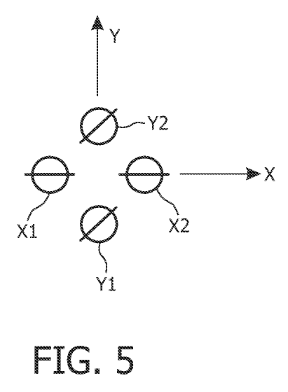

As shown schematically in FIG. 5, the light sources X1,X2 placed along the horizontal axis X emit horizontally polarized light. This may be achieved by using LEDs equipped with a horizontal polarization filter. The light sources Y1,Y2 placed along the vertical axis Y emit diagonally polarized light. This may be achieved by using LEDs equipped with a diagonal polarization filter.

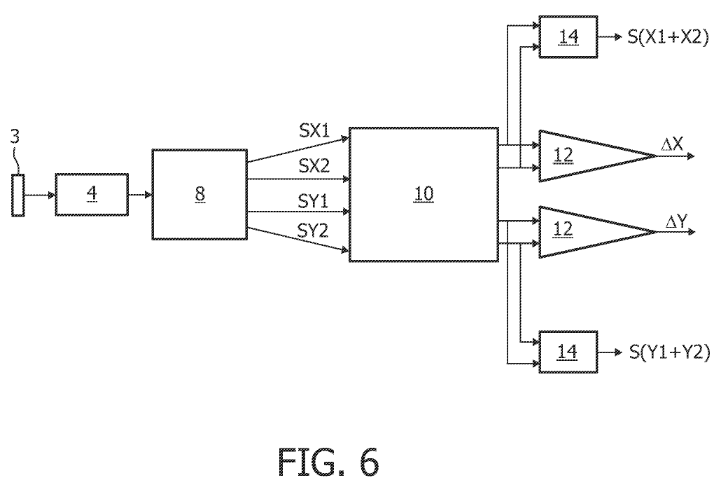

As shown in FIG. 6, according to a first example the detector 4 at the receiving end is equipped with a polarization filter 3. This may be a horizontal polarization filter. The signals SX1,SX2,SY1,SY2 emitted by the light sources X1,X2,Y1,Y2, respectively are separated by a signal separation filter 8. In the case of frequency multiplexed signals this can be done by using band filters for each signal. In the case of time division multiplexing the signals can be separated by a timer. In the case of code division multiplexing the signals are separated by using suitable decoders. In the case of wavelength multiplexing a corresponding detector 4 is needed for each wavelength used.

Then signal strength determining means 10 determine the signal strengths of the four signals. That can be achieved by using a rectifier followed by a low-pass filter for each signal.

Then signal difference determining means 12 determine the difference ΔX between the signals SX1,SX2 emitted by the two horizontally placed light sources X1,X2 and the difference ΔY between signals SY1,SY2 emitted by the two vertically placed light sources Y1,Y2.

The difference ΔX determines the position where the user is pointing in a first direction. The difference ΔY determines the position where the user is pointing in a second direction.

The difference signal can be normalized to compensate for user distance using the most powerful signal. In this way the system does not rely on signal strength, but on difference in signal strength making it less sensitive for environmental (background) light conditions. Also a changing user position hardly influences the system.

Additionally, signal adder means 14 determine the sum S(X1+X2) of the signals SX1,SX2 emitted by the two horizontally placed light sources X1,X2 and the sum S(Y1+Y2) of the signals SY1,SY2 emitted by the two vertically placed light sources Y1,Y2.

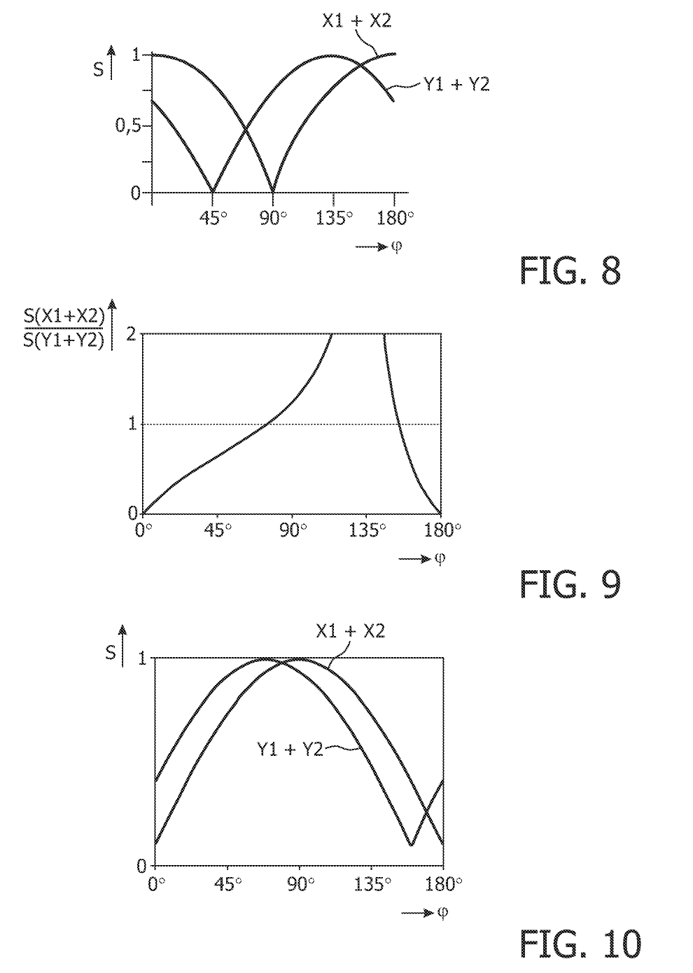

FIG. 8 shows the light strength as a function of the roll angle of the pointing device with the structure according to FIG. 5 for a polarization orientation difference of 45° between light sources on the X-axis and the light sources on the Y-axis. The roll angle of the pointing device can be determined by measuring the light intensity received from both the light sources along the X-axis and the light sources along the Y-axis. In this way, the roll of the pointing device may in principle be detected over an angle range of 180°, because the combination of light intensity values of the sources along the X-axis and the sources along the Y-axis is unique over this whole range of angles. However, the use of signal strengths as such to determine the roll angle in practice is not very accurate, because of variations in the distance between the pointing device 2 and the light detector 4 and due to environmental (background) light conditions. Therefore, it is preferred to use the division of the sum of the signal strength of the light sources along the X-axis and the sum of the signal strength of the light sources along the Y-axis: S(X1+X2)/S(Y1+Y2). In this way the user distance hardly influences the roll angle determination. However, the range of detection of the roll angle is smaller as shown in FIG. 9, depicting the division of the light strengths as a function of the roll angle of the pointing device for a polarization orientation difference of 45°. In this case the roll angle can be detected over an angle range of 135°, because there are only unique values for this angle range.

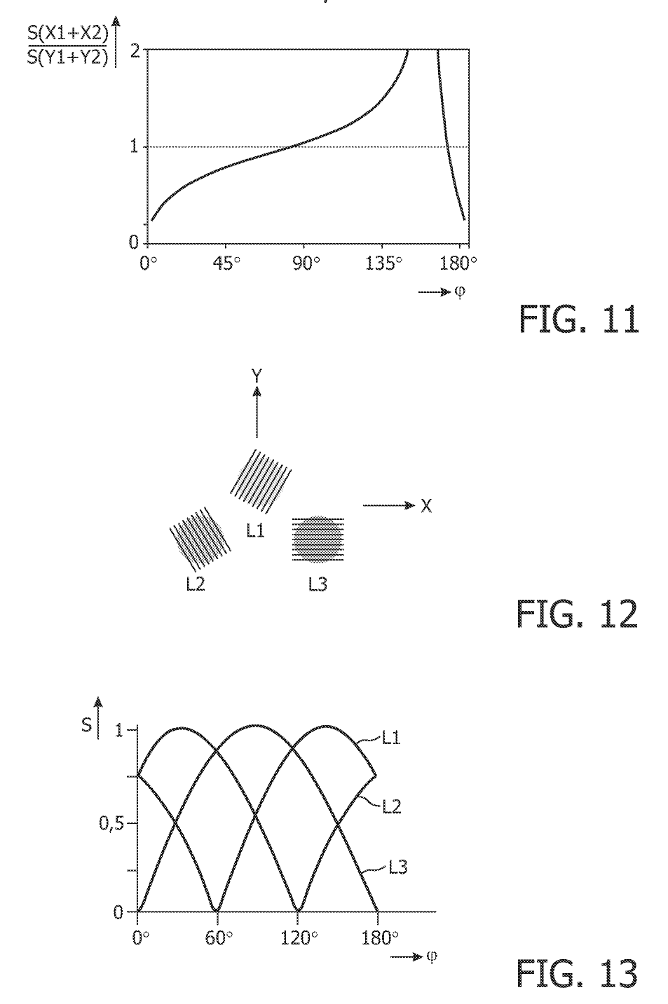

By making the polarization difference smaller the detection angle range is increased but the accuracy will drop. This is illustrated in FIGS. 10 and 11. FIG. 10 shows the light strength as a function of the roll angle of the pointing device with the structure according to FIG. 5 for a polarization orientation difference between the light sources on the X-axis and the Y-axis of 20°. FIG. 11 shows the division of the light strengths as a function of the roll angle of the pointing device for this polarization orientation difference. In this case the roll angle can be detected over an angle range of 160°. However, the detection is less accurate, because the steepness of the division of the signal strengths as a function of the roll angle is not so large as in case of a 45° polarization difference.

On the other hand if the polarization difference between the light sources on the X-axis and the Y-axis is increased, the accuracy increases but only a smaller angle range can be detected.

In the example above 100% efficient light blocking polarization filters are used, blocking 100% light coming in under 90 degrees of the polarizing filter angle. A drawback thereof is that the signal strengths of the light sources along the X-axis and the Y-axis become zero at certain roll angles. For this reason, the pointing direction of the device cannot be properly determined at these angles. For this reason, in practice it is preferred to use less than 100% efficient filters, preferably about 50% efficient filters. 50%-efficient filters block 50% of the light coming in under 90 degrees of the polarizing filter angle. When such filters are used, the “dips” in FIG. 8 will end up on or above the 0.5 light strength value. In this way, it is always possible to detect besides the roll also the pointing direction.

An alternative way to detect the roll and angle-movement/pointing direction with only one detector is to switch the polarization filters on and off, as described in the patent application WO-A-98/38803. The teaching of WO-A-98/38803 is incorporated into this description by reference. The switching can be done in two ways: in the pointing device 2 or in the light detecting arrangement 4 at the receiver side. If the switching is performed with a certain repetition (example 1 kHz) the roll can be detected while polarization filter(s) is (are) enabled, and the pointing direction can be detected when the filters are off.

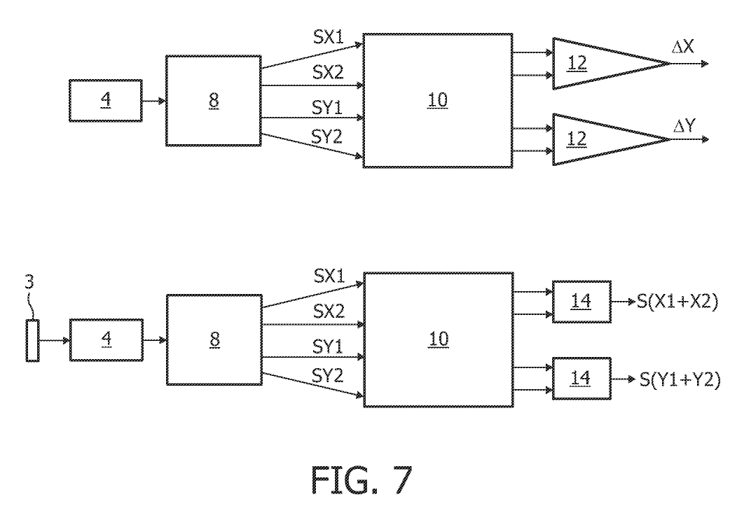

According to a further example as depicted in FIG. 7, at the receiving end two light detectors 4 are present, one with polarization filter 3 and the other one without polarization filter. The detectors are placed close to each other. The light detected by the detector without polarization filter is used for determining the difference ΔX between the signals SX1,SX2 emitted by the two horizontally placed light sources X1,X2 and the difference ΔY between signals SY1,SY2 emitted by the two vertically placed light sources Y1,Y2. These parameters are used to determine the pointing direction of the pointing device. The light detected by the detector with polarization filter is used for determining the sum S(X1+X2) of the signals SX1,SX2 emitted by the two horizontally placed light sources X1,X2 and the sum S(Y1+Y2) of the signals SY1,SY2 emitted by the two vertically placed light sources Y1,Y2. These parameters are used to determine the roll angle of the pointing device. In this arrangement a good determination of both the roll angle and the pointing direction is possible. Polarization filters with a high efficiency may be used.

In an alternative implementation the pointing device comprises an un-polarized reference light source in addition to the signal sources X1,X2 along the X-axis and the signal sources Y1,Y2 along the Y-axis. The signal intensity of this light source as detected by the light detector is used as a reference. In this way, the signal strengths of the signal sources X1,X2 along the X-axis and the signal sources Y1,Y2 along the Y-axis are used for determining the roll angle and not the division of these signal strengths. In this way, the roll angle can be detected over a range of 180°.

According to an alternative example, three light sources L1,L2,L3 are used as shown in FIG. 12. When using three light sources it is possible to detect the pointing position in both the direction of the X-axis and the Y-axis as long as the light sources have a different aim of radiation pattern. Thereto the light sources are pointed a little bit outwards. Light source L3 emits horizontally polarized light. This may be achieved by using a LED equipped with a horizontal polarization filter. The light sources L1 and L2 emit diagonally polarized light. This may be achieved by using LEDs equipped with a diagonal polarization filter. The light sources L1,L2,L3 emit polarized light with 60° difference. FIG. 13 shows the light strength of the light sources L1,L2,L3 as a function of the roll angle for the pointing device with the structure according to FIG. 12 in the case that the light detection arrangement has a vertically polarized filter. Adding a 3^{rd} led with a 3^{rd} polarization enables roll detection for the full 180° angle range, because every combination of the signal strengths of the three light sources is unique over this range. The roll angle can be detected with increased accuracy here due to the high steepness of the signals.

In principle it is possible to detect the rolling angle for a range larger than 180° if the history of rolling is used.

Alternatively, the roll angle can be detected for the whole 360° angle range by adding a detector for detecting the orientation of the light emitting apparatus with respect to the earth. As a general rule this orientation approximately corresponds to the roll angle of the light emitting apparatus. The detector is for example a gravitation or earth magnetic field detector, such as a Hall sensor. In this way, the difference between the upright orientation and the opposite orientation of the pointing device can be detected very easily.

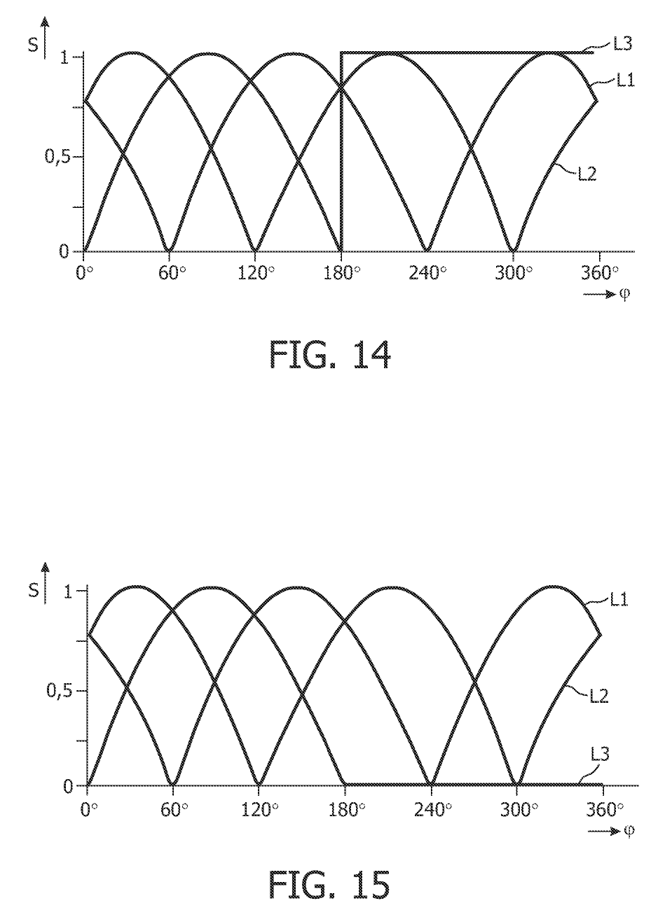

According to a first alternative as shown in FIG. 14, when the detector detects that the pointing device has an upright orientation (i.e. the roll angle is between 0° and 180°) it switches the polarizing filter of one of the LEDs (for example L3) on. When the detector detects that the pointing device has a “turn round” orientation opposite to the upright orientation (i.e. the roll angle is between 180° and 360°), it switches the polarizing filter of the LED off. The detected signal strengths of the LEDs L1,L2,L3 is the same around roll angles of 90° and 270°. The rolling history must be used for detecting these ranges.

According to a second alternative, as shown in FIG. 15, when the detector detects that the pointing device has an upright orientation it switches the power of one of the LEDs (for example L3) on. When the detector detects that the pointing device has a turn round orientation, it switches the power of the LED off.

The detected gravitation or earth-magnetic information can also be transmitted in digital or analogue format to the receiving end by modulating the LEDs or one of the LEDs. At the receiving end the roll angle can be calculated using this information in addition to the intensity of the detected light with a certain polarization orientation coming from the light sources.

The pointing device can be used for numerous applications such as:
Remote control of a TV.
Control of devices that are connected to a display.
Control of other devices by gesturing (e.g. changing volume by moving up or down).

As will be recognized by those skilled in the art, the innovative concepts described in the present application can be modified and varied over a wide range of applications. For example, although the light sources described herein are light emitting diodes emitting infra red light, any other light sources may be used, including light sources emitting visible light. Furthermore, it is also possible to use only two light sources. In this case it is possible apart from determining the roll angle, to determine the pointing position in only one direction.

Accordingly, the scope of patented subject matter should not be limited to any of the specific exemplary teachings discussed, but is instead defined by the following claims. Any reference signs in the claims shall not be construed as limiting the scope.

1. Roll detection system comprising a light emitting apparatus (2), a light detecting arrangement (4) and means for determining a roll angle of the light emitting apparatus around a longitudinal axis (Z) thereof, the light emitting apparatus comprising at least a first light source (X1) being adapted for mainly or exclusively emitting light with a certain polarization orientation and a second light source (Y1) being adapted for mainly or exclusively emitting light with a certain polarization orientation different from the polarization orientation of the light emitted by the first light source, the light detecting arrangement comprising a detector being adapted for mainly or exclusively detecting light with a certain polarization orientation, wherein the orientation of the polarization of the light emitted by the first and second light sources differs by an angle unequal to 90°.

2. Roll detection system according to claim 1 wherein the orientation of the polarization of the light emitted by the first and second light source differs between 10° and 70°.

3. Roll detection system according to claim 1 wherein the different polarization orientation of the light emitted by the first and second light sources is obtained by equipping them with polarization filters (3) with a different orientation.

4. Roll detection system according to claim 3 wherein the light emitting apparatus is adapted for switching the polarization filters on and off.

5. Roll detection system according to claim 1 wherein the light detecting arrangement comprises a polarization filter (3) for mainly or exclusively detecting the light with a certain polarization orientation.

6. Roll detection system according to claim 5 wherein the light detecting apparatus is adapted for switching the polarization filter on and off.

7. Roll detection system according to claim 3 wherein the first and second light sources are equipped with substantially less than 100% efficient light blocking polarization filters.

8. Roll detection system according to claim 1 wherein the light detecting arrangement comprises a further detector for equally detecting light with any polarization orientation.

9. Roll detection system according to claim 1 further comprising a third (X2) and a fourth light source (Y2), wherein the first and the third light source are placed along a first axis (X) and are adapted for emitting light with the same polarization orientation, wherein the first and the third light source have a mutually different radiation pattern and the second and the fourth light source are placed along a second axis (Y) perpendicular to the first axis and are adapted for emitting light with the same polarization orientation wherein the second and the fourth light source have a mutually different radiation pattern.

10. Roll detection system according to claim 1 wherein the light emitting apparatus comprises a third light source adapted for emitting un-polarized light.

11. Roll detection system according to claim 1 wherein the light emitting apparatus comprises a third light source adapted for emitting polarized light with a different polarization orientation than the first and the second light source.

12. Roll detection system according to claim 1 wherein the light emitting apparatus comprises a detector for detecting the orientation of the light emitting apparatus with respect to the earth and wherein the light emitting apparatus is equipped for adapting the light emitted by at least one of the light sources as a function of the detected orientation.

13. Roll detection system according to claim 12 wherein the light emitting apparatus is adapted for switching the at least one light source on in case that the detected orientation of the light emitting apparatus lies in a first range and for switching the at least one light source off in case that the detected orientation of the light emitting apparatus lies in a second range.

14. Roll detection system according to claim 12 wherein the at least one of the light sources of the light emitting apparatus is adapted for mainly or exclusively emitting light with a certain polarization orientation in case that the detected orientation of the light emitting apparatus lies in a first range and for emitting un-polarized light in case that the detected orientation of the light emitting apparatus lies in a second range.

15. Roll detection system according to claim 12 wherein the light emitting apparatus is adapted for transmitting information about the detected orientation by modulating the light emitted by the at least one of the light sources.

16. Light emitting apparatus for use in a roll detection system according to claim 1 comprising at least a first light source (X1) being adapted for mainly or exclusively emitting light with a certain polarization orientation and a second light source (Y1) being adapted for mainly or exclusively emitting light with a certain polarization orientation different from the polarization orientation of the light emitted by the first light source, wherein the orientation of the polarization of the light emitted by the first and second light source differs by an angle unequal to 90°.

17. Light detecting arrangement for use in a roll detection system according to claim 1 comprising a detector (4) being adapted for mainly or exclusively detecting light with a certain polarization orientation and a further detector for equally detecting light with any polarization orientation.

18. Light detecting arrangement for use in a roll detection system according to claim 1 comprising a detector (4) having a polarization filter (3) being adapted for mainly or exclusively detecting light with a certain polarization orientation wherein the light detecting apparatus is adapted for switching the polarization filter on and off.
